(19) United States
(12) Patent Application Publication
(10) Pub. No.: US 2008/0183483 A1
(43) Pub. Date: Jul. 31, 2008

(54) Office management solution

(76) Inventor: Marcia A. Hart, Baltimore, MD (US)

Correspondence Address: Ober, Kaler, Grimes & Shriver, 120 East Baltimore Street, Baltimore, MD, 21202-1643, US

(21) Appl. No.: 12/009,327

(22) Filed: Jan. 17, 2008

Related U.S. Application Data
(60) Provisional application No. 60/880,921, filed on Jan. 17, 2007.

(51) Int. Cl. G06Q 10/00; G06F 17/50

(52) U.S. Cl. 705/1; 703/1

(57) ABSTRACT

A spatial database interface for generally managing assets in a graphical user environment is disclosed, in the particular context of a CAOM office management software solution for managing office facilities inclusive of office layouts (equipment, furniture, information technology assets and other assets) and basic human resources within a physically-defined office space. The software is a web-based custom map application that links a relational database to an SVG or browser rendering format layout map that shows physical locations and relationships among people, rooms and other assets. It imposes a graphical user interface for point-and-click identification of the assets, reporting and reconfiguration (for “what-if” scenarios), and drag-and-drop manipulation of the assets. The software is resident on a web-enabled server hosted by an application service provider. The assets are associated with asset data stored in a web-enabled database and are linked to corresponding visual icons represented on the layout map by embedded HTML elements such as IFrames. All asset data is stored in the database, and robust searching, analysis and reporting capabilities are provided to employ the data.

### CROSS-REFERENCE TO RELATED APPLICATION(S)

The present application derives priority from U.S. provisional application Ser. No. 60/880,921 filed Jan. 17, 2007.

### BACKGROUND OF THE INVENTION

(1) Field of the Invention

The present invention generally relates to a method for facilities management using combined organizational, financial and space design criteria and, more particularly, to a method for office management using software comprising a graphical user environment and spatial database for managing assets and office operations inclusive of office layouts, equipment, furniture, information technology assets, and other assets, and basic human resources within a defined space.

(2) Description of Prior Art

Facilities management includes the management of office layouts, equipment, furniture, information technology assets, human resources, and other assets within a physical office space. In the past, office management has been fragmented into departmental categories. Each department's Information has not been usable by other departments, nor is it compatible with their tracking requirements or systems. Personnel, physical space, and information technology has been and managed separately by the departments of Human Resources, Facilities, and Information Technology respectively. Asset and space allocation and depreciation, if tracked, has been managed by Accounting.

For example, personnel information based on payroll assignment has not been correlated to physical seat or off-site location. Network port locations have not been correlated to users and have not been easily maintained on floor plans. Office equipment identification and locations have not been maintained on floor plans that can be accessed and updated by all managers.

Not only have these different management functions been poorly correlated, but each in itself has been a cumbersome task. For example, in the past facilities management has been a manual effort, very exhaustive and paper-intensive in larger companies, and the question of where to locate people and assets was often based more on seniority or office politics rather than organizational effectiveness. Typically, a facilities manager would acquire a 2D architectural map of the facility and would hand-plot human and asset allocations, updating by hand when necessary. The problems with such ad hoc tracking is compounded by the lack of integration with other corporate information, all of which is interrelated and has an impact on corporate planning and facilities occupancy.

Computer Aided Facilities Management (CAFM) is the application of computer software to the above-described problem to try to reduce the information burden. CAFM typically begins with a CAD floor plan and seating layout. While there are a few existing CAFM software solutions, all rely on a computer-aided drafting of the office space. For example, Aperture™ by Aperture Technologies, Inc. of Stamford, Conn. is a CAFM solution featuring the unique ability to draw over imported Autocad™ and other CAD drawings to establish graphical representations of property assets. This and other known CAFM software is fundamentally a computer aided method for maintaining a seating layout. Thus, existing CAFM is not inherently analytical and cannot assess current or future needs, nor facilitate cost/benefit analyses, etc.

Some CAFM systems have implemented limited process management features. For example, Archibus™ by Archibus, Inc. of Boston, Mass. is a plug-in program to AutoCAD™ that allows users to place design elements such as furniture, equipment, etc., in a database. This database can be used to prepare customized reports and to make instant presentations.

DrawBase™ by Drawbase Software, Newton, Mass. is essentially a basic drawing program that can be used to prepare schedules, reports and space analysis diagrams. Like Aperture™, DrawBase™ can use existing CAD drawings created by other CAD programs and add intelligent attributes to them. These attributes are stored in a database that can be used to prepare reports.

FM:Systems™ of Raleigh, N.C. also offers a collection of software tools including FM:Interact and FM:Space software suites. FM:Interact is suite of web-based applications that allows organizations to access and analyze facilities, real estate and maintenance information. FM:Interact includes separate modules for space management, lease and property management, asset management, strategic planning, move management, and service request management. The modules collectively house employee information, floor plans, reports and other documented facilities information, and allows dynamic management of space efficiencies and facilities such as furniture, equipment, computers, life safety systems, building systems and artwork. FM:Space provides many of the same capabilities in a standalone software package, and additionally integrates with AutoCAD™ to allow existing drawings to be used.

U.S. Patent Application Publication Number 2005/0086093 shows systems and apparatus for use in asset management. The apparatus displays an image of a floor plan to a user. Further, the apparatus allows the user to select from a plurality of indicators, where each indicator represents a respective asset. Following selection, the apparatus allows the user to position the indicators on the image of the floor plan in respective positions reflecting the physical location of the respective assets. The invention allows the user to group assets, create group layers, and store information about each, as well as other asset management features.

U.S. Patent Application Publication Number 2004/0113937 shows a system and method for dynamic integrated computer-aided facilities management. The method includes selecting a resource to view and retrieve data relating to the resource. The method also includes generating an interactive graphic representing the resource from the data, incorporating links to the data in the interactive graphic, and outputting the interactive graphic. The method may also include converting a standard graphics file into data for use in generating the interactive graphic. The system includes a user interface for requesting a graphic representing a resource, a data source comprising data related to the resource, and a graphics generator for dynamically generating an interactive graphic representing the resource. The interactive graphic is generated from the data in the data source. The interactive graphic allows a user to view data relating to the resource within the interactive graphic.

U.S. Patent Number 2002/0178100 shows an asset performance management system to link asset suppliers, asset users and an asset manager. The system includes data store to store asset related information in accounts held by respective asset suppliers and users. The system also includes an interface maintained by the asset manager to provide a central access to the database by asset suppliers and users, for them to enter, modify and view asset related data in permitted accounts, and to enable communications between the asset suppliers and users. The system further includes a reporting function operated by the asset manager to monitor asset performance and provide asset performance assessments for assets in the accounts to the respective account holders. In a further aspect, the invention relates to a method of providing asset performance management to suppliers and users of assets.

U.S. Patent Application Publication Number 2005/0171876 shows a wireless asset management system method for the identification, monitoring, and tracking of people or objects. More specifically the system relates to a wireless data gathering network, whereby the data is processed and delivered to a predetermined number of devices for visual or automated reading. A plurality of applications are made possible by the processing of said data, such as, but not limited to, safety, security, payroll, finance, business operations, emergency reporting and response, sensor manipulation, inventory control, physical plant controls, and system wide self-diagnostics.

The problem with the foregoing efforts is that they all rely on previously established CAD (usually AutoCad™) drawings and their associated databases. Any visualization of a building is done, normally, in vectors. Architects create/design all buildings today through CAD in a vector format, i.e. AutoCAD™ DWG or DXF format. Most large companies have CAD drawings or other geo-spatial drawings at their disposal that reflect their office space, but they lack the interface to use the geo-spatial data for personnel, information technology (IT) and asset management.

Real-time building visualization and control requires a dynamic rendering format, such as provided by Adobe Flash™, Java FX™, Microsoft Silverlight™, SVG Viewer or like browser plugin that integrate with a Web browser as and is capable of vector rendering methods plus other features like animation, audio-video playback, etc. SVG (Scalable Vector Graphics) is the current web standard text-based graphics language that describes images with vector shapes, text, and embedded raster graphics. SVG makes it possible to represent graphic information in compact, portable form for publishing spatial vector graphics such as CAD drawings in a network environment. These capabilities make it possible to display a broad range of attributes for an object and can be linked to a comprehensive relational database. The published graphics are displayed in a web-browser, making dynamic corporate information accessible to unlimited authorized users via an Internet connection

Accordingly, there is a need in the art for a spatial database interface that enables most any facility manager to manage assets and associated asset data in a graphical setting.

There is a more particular need for an information management tool that takes advantage of spatial display and holistically integrates relationships between corporate departments' primary areas of responsibility. It would be greatly advantageous to fulfill these and other needs with a software solution that elevates traditional Computer Aided Facilities Management (CAFM) to a more comprehensive Computer Aided Office Management (CAOM) solution to enable facilities managers to more cost-effectively manage assets and associated asset data within a graphical layout plan of a building or other facility.

### SUMMARY OF THE INVENTION

It is therefore the primary object of the present invention to provide spatial database interface software that integrates a browser-enabled database with a spatial user interface so that users can see and update locations and attributes for database objects using a searchable graphic display.

It is another object to provide an office management solution that is user-friendly and offers the most accessible and easiest-to-use database solution available, with capabilities for multi-department use and input within an organization. It is another object to provide an office management solution with a visual floor plan interface that makes viewing and editing completely intuitive and visual, such that any subscribing user can use the interface with no special training.

It is another object to provide an office management solution for managing facilities, IT and basic HR data and processes, via a web-enabled third party application-service provider (ASP) platform.

It is another object to provide an office management solution with a visual floor plan interface in which both people and assets can be moved with a single drag-and-drop action, and subscribers can easily study alternatives with “what if?” scenario capabilities.

It is another object to provide a CAOM solution with natural language search capabilities to locate any asset by a filtered search can find it/them quickly and easily.

It is another object to provide a CAOM solution with robust analysis and reporting capabilities that yield ready access to key management data such as space forecasting for budgetary reasons, reports such as work orders for moves, adds & changes, financial reports and depreciation schedules, and with business continuity planning and disaster recovery features.

It is another object to provide a CAOM solution with health and safety planning capabilities such as emergency egress plans (viewable on any desktop), highlighted areas of refuge, ready identification of specific employees needing emergency aid, and highlighted hazardous materials locations and disaster supplies with location and aging schedules.

It is another object to provide a CAOM solution with a new ability to reduce costs for underutilized, redundant, or outdated assets, capture corporate standards and bulk purchasing opportunities, and justify cost allocations with accurate information.

It is another object to allow comparison of local utilization against industry-wide, and/or national peer benchmarks, all possible using an ASP approach, and not available in traditional CAFM software packages installed on corporate networks.

It is a general object to provide a COAM solution with the ability to manage office operations that require inputs from multiple departments, such as employee status change, new hire and termination processing that requires coordination among HR, Facilities and IT departments.

It is a general object to provide a COAM solution that incorporates business continuity features including off-site storage of office operations data, asset inventory data management for insurance claims, and alternative work site options available within the corporate real estate footprint.

In accordance with the foregoing objects, the present software is a CAOM office management software solution for managing office operations inclusive of office layouts (equipment, furniture, information technology assets, and other assets) and basic human resources within a physically defined office space. The software is a web-based custom map application that links a relational database to a layout map that shows physical locations and relationships among people, rooms and other assets. It imposes a graphical user interface for point-and-click identification of the assets, reporting and reconfiguration (for “what-if” scenarios), and drag-and-drop manipulation of the assets.

The software is resident on a web-enabled server (hosted by an application service provider). Subscriber floor plan maps (blueprints of office facilities) are converted into scalable vector graphics drawings, or other vector, raster or bitmap formats capable of being rendered in a browser) and are loaded as desired into the software. Subscribers can display a given floor plan by opening it within the user interface of the present software. Assets can then be positioned on the floor plan by clicking and dragging asset icons onto the floor plan, thereby embedding an object onto the floor plan which populates the floor plan with the corresponding asset data derived from the web-enabled database. All relevant object data is stored in the database, and so when a user points to a particular asset on the floor plan the corresponding asset data is displayed proximate thereto. The software also provides robust searching, analysis and reporting capabilities of the database to make best use of the data.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a block diagram of the business method for combining organizational, financial and space design criteria into the project planning process according to the present invention.

FIG. 2 is a block diagram of the method for upcoding CAD floor plans into vector graphic format according to an embodiment of the present invention.

FIG. 3 is a diagram of the JAVA Publisher™ web layout illustrating the primary components of an exemplary user-interface 100 to the software for implementing the method of FIG. 1.

FIG. 4 is a screen print of an exemplary user-interface 100 according to the present invention.

FIG. 5 is an exemplary field map for Customers and Buildings as employed in the software of the present invention.

FIG. 6 is an exemplary field map for Spaces and Positions employed in the software of the present invention.

FIG. 7 is an exemplary field map for Persons which contains all information relevant to individuals as employed in the software of the present invention.

### DETAILED DESCRIPTION OF THE PREFERRED EMBODIMENTS

The present invention is a general business method and implementing software method for providing an automated Computer Aided Office Management (CAOM) solution for managing office facilities inclusive of office layouts (equipment, furniture, information technology assets, and other assets) and basic human resources within a confined office space.

The present CAOM business method combines organizational, financial and space design criteria into the project planning process, and the software component facilitates the facilities management process.

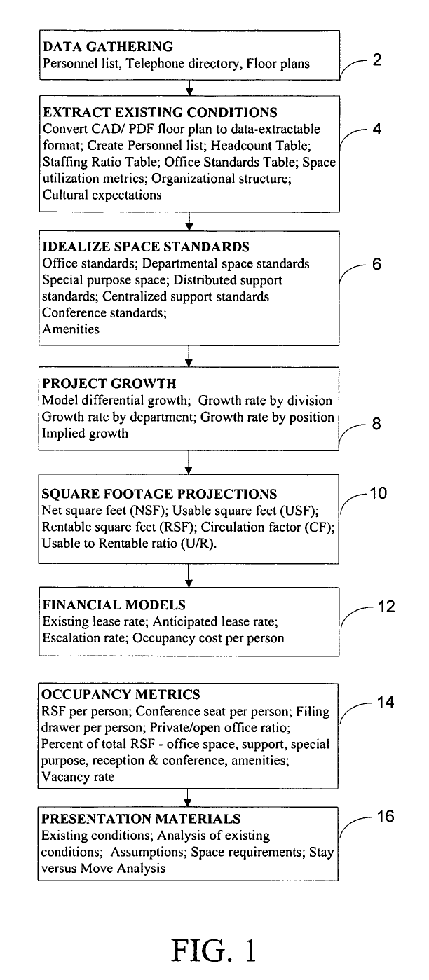

FIG. 1 is a block diagram of the business method for combining organizational, financial and space design criteria into the project planning process.

A first step 2 entails gathering particular human resource and facilities data necessary to support the project planning analysis conducted herein. This data is entered into the CAOM office management database of the present invention. Specifically, the data includes the following:

Personnel list—list of local payroll employees with name, title and department.

Telephone directory—lists all extensions including non-payroll personnel, active conference rooms with telephones, indicates reporting relationships/secretaries, special roles, emergency contacts, off-site personnel.

Floor plans—architectural drawings including locations of payroll and non-payroll personnel, personnel in offices and workstations, equipment, support space, filing, conference rooms, amenities, storage, work flow adjacencies, etc.

The second step 4 entails extracting existing conditions from the gathered data. This data is entered into the CAOM office management database of the present invention.

The Floor plans (in CAD or PDF format) are converted to a data-extractable format as will be described.

A Personnel List is created (an actual on-site inventory, not the above-referenced payroll list)—name, title/position, department, personnel type (F/T, P/T, seasonal, contractor, etc.), office type, etc.

A Headcount Table is created—by division, department, position, personnel type.

A Staffing Ratio Table is created—e.g. Partner, Associate, Attorney, Secretary, Manager, Staff, etc.

An Office Standards Table is created—actual office assignment by position/title.

A Space utilization metrics Table is created—Personnel space, Departmental space, Special purpose space, Distributed support space & equipment, Centralized support space, Amenities, Storage.

An Organizational structure table is created—Divisions, departments, adjacencies.

A Cultural expectations table is created—hierarchy, private vs. open office ratio, natural light, etc.

The third step 6 entails determining the ideal space standards for the current situation, including office standards, departmental space standards, special purpose space, distributed support standards (persons per shared printer, per pantry, per copy room, etc.), centralized support standards (office services, it server & configuration, records, etc.), conference standards (type, quantity, pers. per total conference seat count, ancillary conference support and hospitality), amenities (food service, health and wellness, fitness, family care, entertainment, etc.). As above, this data is entered into the CAOM office management database of the present invention.

The fourth step 8 entails estimating Projected Growth. This entails developing analytics to model differential growth by position and department. The results include Growth rate by division; Growth rate by department; Growth rate by position, and Implied growth as a function of staffing ratios. This data is entered into the CAOM office management database of the present invention.

The fifth step 10 entails calculating Square footage projections based on the foregoing growth models and idealized space standards. The square footage projections include bracket rentable square footage over lease period; move-in, first expansion option, lease termination, Net square feet (NSF), usable square feet (USF), rentable square feet (RSF), Circulation factor, Usable to Rentable ratio. This data is entered into the CAOM office management database of the present invention.

The sixth step 12 entails developing financial cost models for various real estate alternatives. The cost models depend on predetermined variables including existing lease rate, anticipated lease rate, escalation rate, occupancy cost per person/attorney, etc. This data is entered into the CAOM office management database of the present invention.

The seventh step 14 entails determining occupancy metrics including rentable square feet (RSF) per person/attorney, conference seat per person/attorney, filing drawer per person/attorney, private/open office ratio, percent of total RSF—office space, support, special purpose, reception & conference, amenities, Vacancy rate. This data is entered into the CAOM office management database of the present invention.

Finally, the eighth step 16 entails taking the results of the above-described data collection and analysis steps, all of which at this point have been entered into the CAOM office management software solution, and using the software to generate reports or manage the data. This may typically comprise a display or print presentation materials portraying existing conditions (color coded floor plans highlighting relevant conditions; e.g. vacancies, departmental space allocation, space use type, adjacencies and distribution of special space, security zoning), and an analysis of existing conditions which may include alternative scenarios (Stay vs. Move analysis, renovations & costs analysis, etc.), or day-to-day management such as Floor plan based seating plans (that maintain seating plans over time); floor plan based asset management (that maintains equipment records using floor plan); floor plan visualization reporting (vacancies, departmental areas, space use, etc.); business continuity planning (vacancy reporting, equipment and support availability); emergency planning (floor plan based evacuation plan, highlight special assistance requirements); disaster recovery (displaced personnel, inventory management, insurance reporting); analytical reports (occupancy metrics, financial metrics); requirements projections (growth modeling, space requirements, financial modeling).

The present software is preferably implemented on a web-enabled third party application-service provider (ASP) platform using a traditional application service provider (ASP) framework with conventional web-enabled computer server and standard supporting software. While more or less powerful computer systems can be used, it is suggested that the computer system employ one or more back-end web-enabled server(s), database and website all maintained by a the ASP, and all subscriber-Manager communication may take place over the Internet. The back-end Manager server(s) may run on a web-enabled Microsoft platform, such as Windows 2000 Advanced Server edition hosting a conventional database application such as MS SQL Server 2000, though these are exemplary components only and other web-enabled platform will suffice. All the above-described data may be gathered via a website (to be described) and used to populate an SQL (or other suitable) database. This architecture is fully scalable to meet growing demand.

Subscribers access the website by conventional PC's equipped with a conventional color monitor, a modem or broadband connection, and standard input devices including mouse and keyboard. The operating system may be Windows Vista, XP or equivalent, and a conventional browser such as Windows Internet Explorer™ is required (the software is cross-platform compatible and may be run in Firefox™, Safari™ or any other browser with Java and HTML compatibility).

The website is available to subscribers on a subscription basis which is billed monthly according to floor plan area and personnel headcount, plus a one-time setup fee for the ASP Manager's assistance in steps 10-14 above.

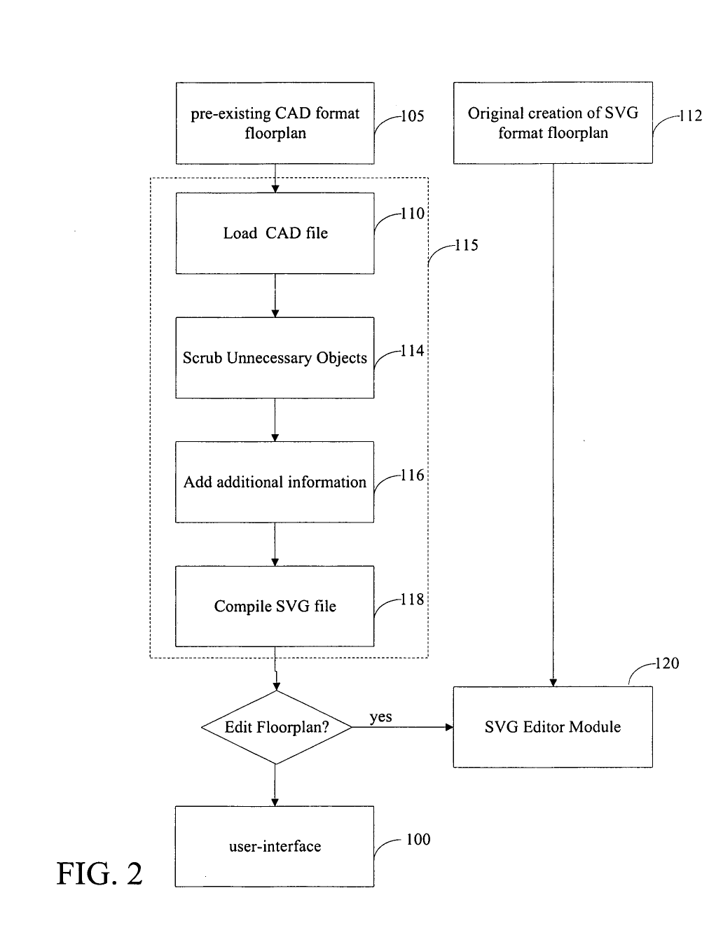

FIG. 2 is a more detailed block diagram of the extract existing conditions: Convert CAD/PDF floor plan to data-extractable format step 4 of FIG. 1. As seen in FIG. 2, this begins either with a pre-existing SVG format floor plan at step 105, or with original authoring of a floor plan in SVG format at step 112.

If, at step 112, there is no floor plan and it is necessary to compile one from scratch, the user may rely on a conventional vector drawing program, designated SVG editor module 120, preferably capable of editing in SVG format. There are a few existing drawing packages that support SVG format, including Adobe Illustrator™, Corel Draw™, and Inkscape™. Alternatively, a traditional CAD authoring package may be used to create a DWG or DXF formatted floor plan, and this floor plan may be converted to SVG as at substeps 110-118 described below.

If, at step 105, there is an existing Subscriber floor plan (blueprint of office facilities), then it will typically be in DWG or other format and must be converted into SVG format. The present software accomplishes this with a CAD Import module 115. The CAD Import module 115 opens the DXF or DWG file at substep 110, and translates the existing CAD formatted (DXF or DWG) file and saves it as a Comma Separated Value (CSV) or Text (TXT) file.

Because the existing floor plan data may be in a format which embodies unnecessary additional data, legends, map layers or text, unneeded objects are removed or “scrubbed” from the CSV file at step 114.

The remaining objects may then be embellished with additional information in substep 116. Whenever any additional objects are needed to describe any structure or the environment, they are added here. Such objects typically include simple lines to representing walls or the sides of buildings or they may be polygons or polylines or other obstructions.

Once any surplus data has been scrubbed, or any missing data has been entered, the CAD import module 115 exports the interim CSV or TXT file to SVG format at substep 118.

Subscribers provide their own CAD file or PDF file of their facility floor(s) for use as basemap(s), along with basic occupancy data, and the foregoing steps are performed by the third-party Manager for the initial set-up fee. Thus, the ASP Manager creates the SVG facility maps and associated database for the subscribing client. The present web interface is deployed on the internet so that authorized subscribers can login and see floor plans and search the database for personnel and departmental or team locations, facilities and furniture data, and computers and equipment assets. There are different levels of user-rights such that subscribers may log in as an Administrator with additional privileges to generate reports and change database data, and full Maintenance users can login to generate reports and change all database data.

Once the basemap(s) and database data is deployed on the web-enabled server, subscribers may use any remote computer workstation to login to a central URL and access the SVG file in the graphical user interface of the present software. The SVG floor plan file becomes the base layer or background layer.

When the graphical user interface is initialized all structural objects are loaded into session parameters from the database and any changes are recorded over the session parameters for later saving/loading of the graphic. This allows the user to try “what-if” scenarios without committing to the changes.

The graphical user interface comprises a Sun MicroSystems™ JAVA applet written in Web Publisher™ that runs on each local desktop and interacts with files managed by the Web Server. With Web Publisher, any user can directly access, edit, and manage documents stored on remote servers.

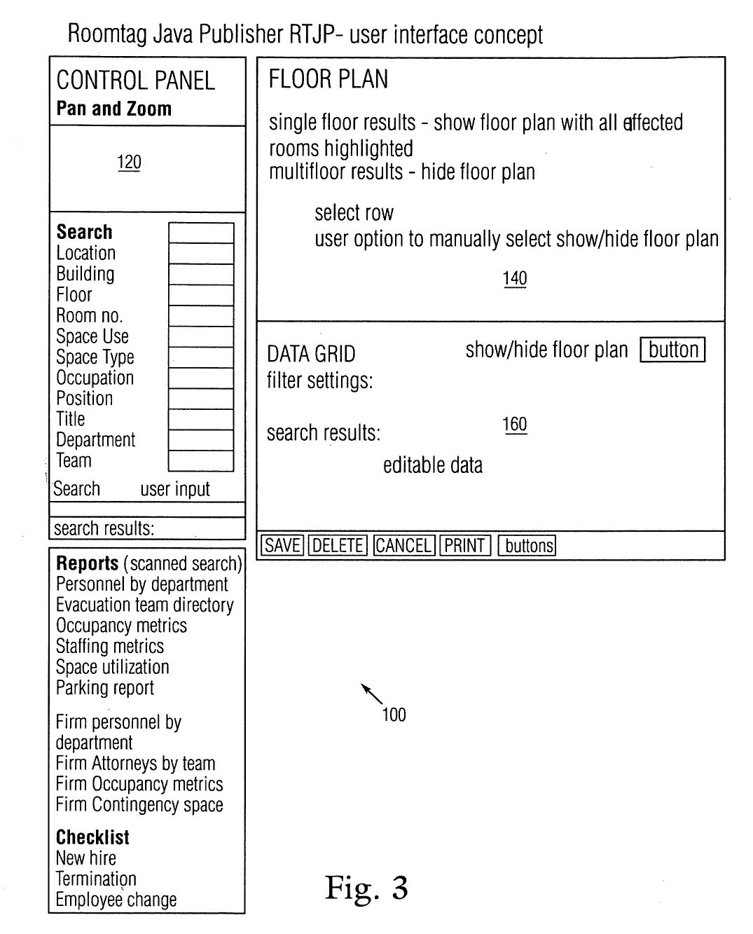

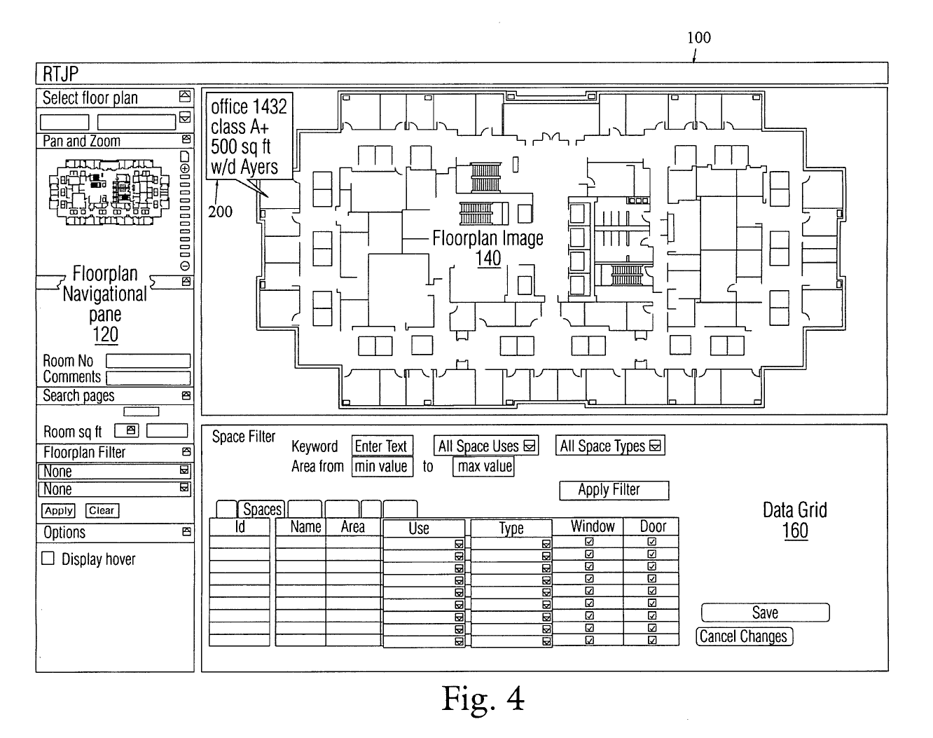

FIG. 3 is a diagram of the JAVA Publisher™ web layout illustrating the primary components of the user-interface 100, and FIG. 4 is a screen print of the actual user-interface 100 according to the present invention.

The user interface 100 generally comprises a floor plan navigation panel 120 at left, floor plan editing panel 140 at top right, and a data grid 160 at bottom right.

Using the floor plan navigation panel 120 a subscribed user may define people and/or assets and then add them into the floor plan editing panel 140 simply by dragging icons from one to the other across the partition, and placing them as desired. To facilitate this, the asset data collected in step 2 (human resource and facilities data) is classified by type and is used to populate the database.

In general terms, the table below outlines the classification scheme by asset class, subclass and genre (nomenclature subject to change) with examples.

Asset Class, SubClass and Genre with examples.

| Asset Class | SubClass | Asset Type | Attributes (for each asset class) |
|---|---|---|---|
| Person | Officer | | Name |
| | Employee | | Title |
| | Contractor | | Member of group(s) |
| | Unaffiliated | | Responsible for |
| | | | Reports to |
| | | | Status (active, pending, superceded, |
| | | | retired) |
| | | | First day of status |
| | | | Last day of status |
| | | | Security clearance |
| | | | CPR certification |
| | | | Medical assistance |
| | | | Evacuation assistance |
| Org Entity | Company | | |
| | Firm | | |
| | Association | | |
| | Agency | | |
| | Division | | |
| | Business unit | | |
| | Department | | |
| | Team | | |
| | Set | | |
| Space | Campus | | Coordinates |
| | Site | | Area (square feet) |
| | Quadrant | | Name |
| | Building | | Number |
| | Floor | | Occupancy category (personnel, |
| | Defined area | | support, conference &training, |
| | Room | | Special purpose, amenity) |
| | Defined area | | Area of refuge (role) |
| | Workstation area | | Egress system (role) |
| Property | Systems Furniture | Workstation | Manufacturer |
| | (fixed) | Panel | Model |
| | | Worksurface | Color |
| | | Accessory | Size |
| | | | Date of purchase |
| | | | Basis cost |
| | | | Depreciation value |
| | Port | Data port | Port ID |
| | (fixed) | Voice port | Jack type |
| | | | Status |
| | | | Panel termination |
| | | | Installation date |
| | Furniture | Chair | Manufacturer |
| | (incl. furnishings) | Table | Model |
| | | Pedestal | Size |
| | | Mobile cart | Color |
| | | Keyboard tray | Condition |
| | | Artwork | Date of purchase |
| | | Recycling Bin | Basis cost |
| | | | Depreciation value |
| | Equipment | (Datacomm) | Manufacturer |
| | | Computer | Model |
| | | Monitor | Size |
| | | Laptop | Color |
| | | Blackberry | Condition |
| | | Mobile phone | Date of purchase |
| | | Desktop phone | Basis cost |
| | | PDA | Depreciation value |
| | | (Office services) | |
| | | Copier | |
| | | Printer | |
| | | Scanner | |
| | | Fax machine | |
| | | Postage machine | |
| | | Shredder | |
| | | (IT infrastructure) | |
| | | Router | |
| | | Rack | |
| | | Panel | |
| | | (Facilities) | |
| | | Refrigerator | |
| | | Dishwasher | |
| | | Microwave | |
| | | Coffee machine | |
| | | Water machine | |
| | | (Security) | |
| | | Security access card | |
| | | (Life Safety) | |
| | | First aid kit | |
| | | Defibrillator | |
| | | Fire extinguisher | |
| | | Manual pull station | |
| | | Parking permit | |

The foregoing data inclusive of Asset Class, SubClass and Type are stored for each basemap as fields in a table and relational links are drawn between corresponding Asset Class, SubClass and Types. The data is also categorized by discipline and access level to enable filtering and role-based security features.

As a more specific example, the presently-preferred website implementation employs the following asset classification scheme.

| Asset Class | Purpose |
|---|---|
| Customers | A company including its collection of |
| | people or assets (container class) |
| Building | The physical location |
| Person | An individual with a relationship to |
| | the company or its assets (object class) |
| Position | Titles assigned to persons |
| Space | A defined area (container class) |
| Property | A physical object. (object class) |
| | Property may be mobile (chair, computer) or fixed |
| | (dataport, built-in furniture). |

Each data type is associated with a plurality of linked tables containing defined fields for that data type.

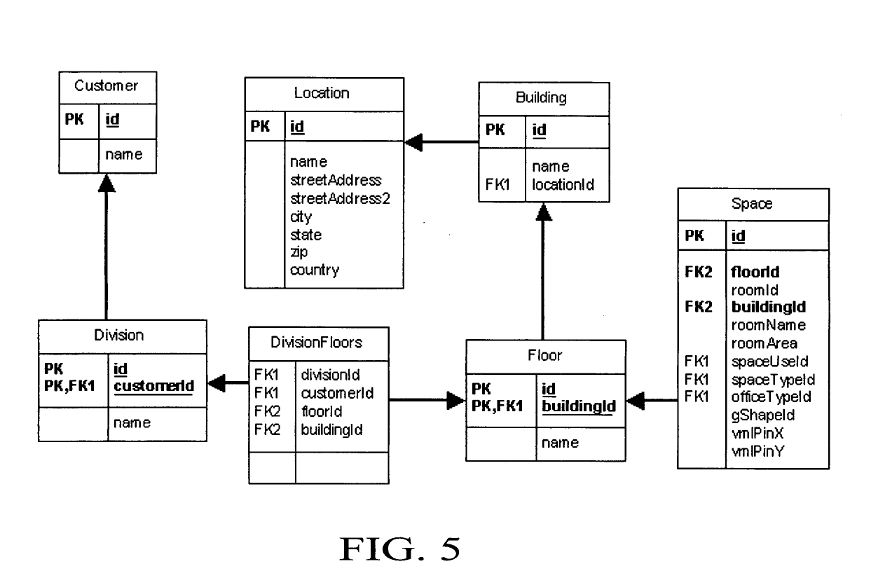

FIGS. 5-7 are field maps illustrating the arrangement of tables, fields and interrelationships for the various data types. Specifically, FIG. 5 is the field map for Customers and Buildings. The customers table includes relevant subscriber information, and buildings include building information.

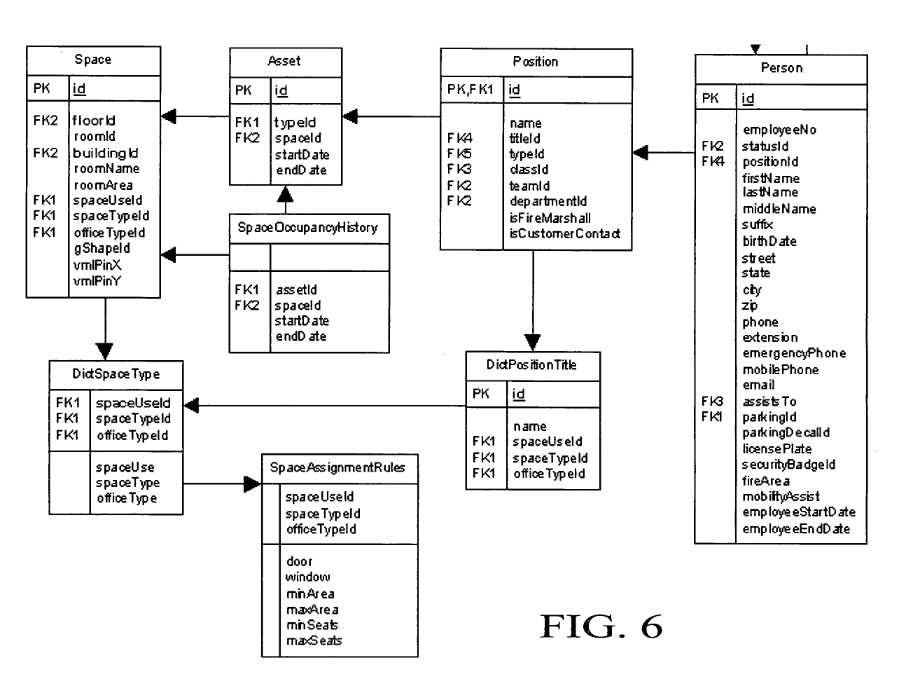

FIG. 6 is the field map for Spaces and Positions.

The Spaces class includes SpaceUse (Office, Copy room, etc.); Space Type; Office Type (Oversize, Undersize, etc.). In accordance with one unique aspect of the present software, the spaces class is defined by an office evaluation as per below which grades the office spaces (A+ through G) based on whether it has a door, window, area, and other variables.

| Office | | | Area | Area | | |
|---|---|---|---|---|---|---|
| Type | Door | Window | Min | Max | MinSeats | MaxSeats |
| A+ | Y | y | 240 | 300 | 1 | 1 |
| A | Y | Y | 190 | 239 | 1 | 1 |
| A− | Y | y | 170 | 189 | 1 | 1 |
| B | Y | Y | 125 | 169 | 1 | 1 |
| B− | Y | y | 90 | 124 | 1 | 1 |
| B′ | Y | N | 125 | 165 | 1 | 1 |
| C | Y | N | 90 | 120 | 1 | 1 |
| D | N | N | 48 | 90 | 1 | 1 |
| E | N | N | 36 | 64 | 1 | 1 |
| F | N | N | 1 | 3000 | 1 | 1 |
| G | Y | N | 120 | 260 | 1 | 1 |

The Positions table includes personnel position definitions such as Contractor, Full time, Part time No Benefits, etc. The positions table also assigns each defined position to a corresponding office grade defined above. For example, Accountant may be entitled to a grade C office, senior vice presidents to A−, and mail clerks to G. When using the software, these grade assignments are compared to a predetermined ruleset that governs the assignment/reassignment of persons to offices.

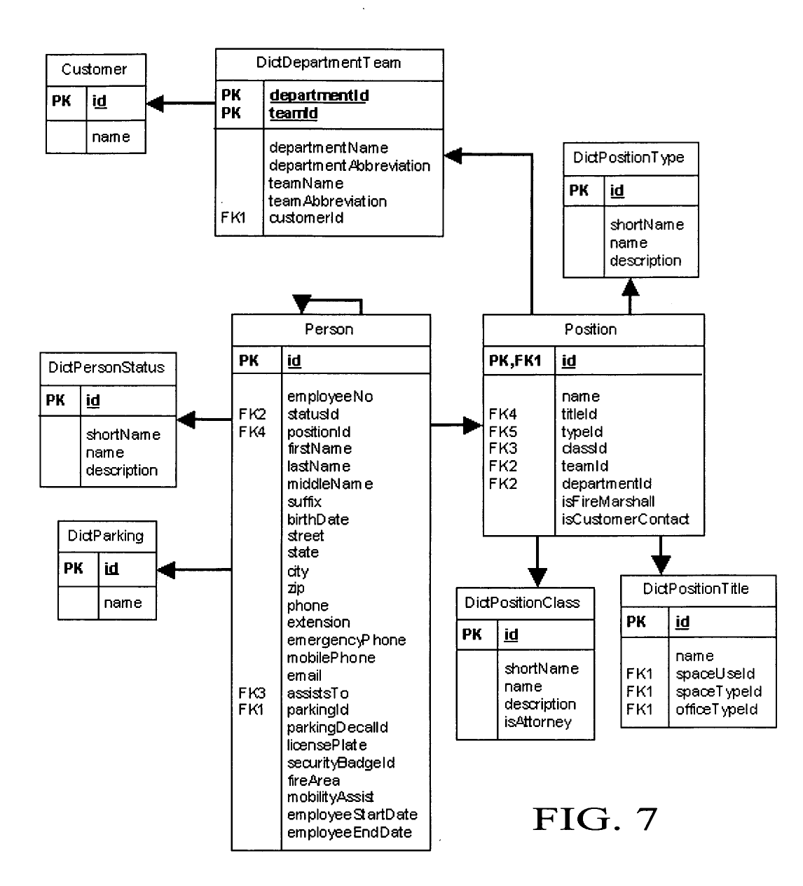

FIG. 7 is the field map for Persons which contains all information relevant to individuals.

In the foregoing manner of classification and definition, all characteristics of people and/or assets are defined by completing the data fields in the respective tables.

This classification scheme allows for the ASP Manager's definition of a client's entire floor plan, complete with assignments of people and equipment assets.

Beginning with the vector-graphics floor plan object (described above) for the entire floor, the now-defined assets may be assigned to particular locations. For example, room objects for each room or space may be assigned to the floor plan including room occupancy, room type, cost allocation tracking; personnel objects (people) including name, position, departments, project teams, manager teams, birthday, etc. Structural objects may be assigned such as partitions; furniture assets; equipment assets; information technology (IT) assets; and even move and change reports and work orders; lease data objects; etc.

This categorization of the database data and the relationships drawn is an essential feature of the present database architecture as it allows robust manipulation, analysis and reporting capabilities (to be described).

Each defined asset in the database is also represented by an assigned icon in the floor plan 140 of FIG. 4, and additional objects may be created by the user as desired.

The software employs an AJAX architecture coded primarily in XML. In an exemplary implementation, each defined object (other than the basic floor plan) represents an HTML element embedded inside the main floor plan document. This may be accomplished, for example, using embedded HTML. Iframes are one example of a suitable HTML embedding scheme. Iframes are web-page-like elements that can be embedded in the floor plan background page. Each defined object has its own source URL, distinct from the floor plan background URL, and the source URL is populated dynamically from a web-enabled database. Thus, when an icon (object) is positioned on the floor plan background the corresponding icon or visual tag (and associated HTML) is embedded directly in the floor plan URL. A visual representation is may also preferably provided proximate the floor plan for people and assets who do not have an assigned physical location, to allow management of these as well. The icon object HTML coding is responsive to a mouse pointer, and when the subscribed user hovers the mouse pointer over an object it is interpreted as a call to the embedded object URL of interest. The underlying database information for that object is retrieved and is displayed in a bubble window immediately adjacent to the designated object, as seen by window 200 in the floor plan editing panel 140 of FIG. 4. Assuming the database fields for that object were pre-populated the object information will appear in bubble window 200 whenever the user hovers their mouse pointer over the respective object, for example, Office 1432, class A, 500 square feet, window+door, currently assigned to Ayers. This embedded HTML methodology (IFrame or otherwise) is known in other contexts and, for instance, has been used to link database information to visual representations on Google Maps™ and Netflix.

Referring to FIG. 4, navigation of the three panels of the user-interface 100 of the present invention is an essential feature of the invention. The information displayed in the floor plan navigation panel 120 at left affects the floor plan editing panel 140 at right, and so too does the data grid 160 at bottom right, all three pulling from the same database. More specifically, the floor plan navigation panel 120 at left includes a thumbnail icon of the floor plan with a zoom feature, plus an underlying search panel that allows searching for any asset based on any defined variable and filter. If a subscriber points and clicks on any asset in the floor plan icon or searches and finds an asset in the search window, the asset is highlighted yellow in the floor plan editing panel 140 to the right. Moreover, the relevant database information appears in the data grid 160 at bottom right. The data grid 160 is editable (provided the user has proper permissions) and the variables for that asset can be edited as desired. There is click-and-drag functionality and so assets can be freely reassigned by moving them around the floor plan editing panel 140, and newly assigned by clicking-and-dragging from the floor plan navigation panel 120 onto the floor plan editing panel 140. For each assignment/reassignment, the user is prompted to accept/cancel the change, and if accepted the database is updated accordingly and the updated information appears in the data grid 160.

As stated above the present software is preferably deployed on one or more web-enabled backend servers hosting a resident database and the user interface of FIGS. 3-4 in the form of website that can be reached by subscribers at an appropriately named URL such as, for example, Roomtag.com.

The back-end web-enabled server(s), database and website are maintained by the ASP Manager, and all subscriber-Manager communication may take place over the Internet. The back-end Manager server(s) may run on a web-enabled Microsoft platform, such as Windows 2000 Advanced Server edition hosting a conventional database application such as MS SQL Server 2000, though these are exemplary components only and other web-enabled platform will suffice. Data extracted from the website (to be described) populates the SQL (or other suitable) database with the object information. This architecture is fully scalable to meet growing demand.

In addition to the interactive, on-screen data visualization capabilities apparent in FIG. 4, a set of user controls is provided to allow scroll, pan, and zoom functions over the base facilities maps. As in most GPS mapping applications increasing amounts of asset information are displayed with increasing zoom levels. In addition, the user can open multiple base maps to view multiple floors or multiple locations at once.

Since all asset data is stored in a central database assets can be searched and located to find specific details (such as, e.g., by employee name, etc.). The search window in the floor plan navigation pane 120 preferably employs a natural language search engine to facilitate more user-friendly searching. For example, a user can search based on the following searches:

Where does Tom L. sit?

How many HP Laserjet III printers do we have?

Are there any employees on this floor who need assistance in an emergency?

How many of our desktop computers are more than 3 years old?

The above-described visualization and search functions facilitate numerous forms of computerized asset resource management, including:

floor plan based seating plans—maintain seating plan over time;

floor plan based asset management—maintain equipment records using floor plan;

floor plan visualization reporting—vacancies, departmental areas, space use, etc.;

business continuity planning—vacancy reporting, equipment and support availability;

emergency planning—floor plan based evacuation plan, highlight special assistance requirements;

disaster recovery—displaced personnel, inventory management, insurance reporting;

analytical reports—occupancy metrics, financial metrics; and

requirements projections—growth modeling, space requirements, financial modeling.

In addition to the visualization and search functions, the present software provides a very robust data analysis module and reporting module to make best use of the asset data. The analysis module allows design analysis and scenario modeling for various situations such as lease negotiations and real estate development. It generally combines financial variables, design alternatives, scheduling and phasing, construction cost and occupancy metrics from the database to project business implications of space decisions and asset allocation rapidly and accurately. The intent of the analysis module is to provide ready data needed to answer fundamental office occupancy questions definitively, such as:

How much space do we really need?

Should we stay or move?

Do multiple offices cost more or less than a consolidated location?

Should we accept our next lease option?

How do we develop a merger migration plan?

For example, the analysis module calculates the square footage per employee by summing the total rentable square footage in a given floor plan and dividing by the planned occupancy derived from the total employee objects positioned on the basemap. This is displayed along with benchmark data to provide a ready comparison to established industry norms. Such analysis was not previously possible except by laborious manual collating of information. The software can be used to collect benchmark data across multiple clients that allows analysis of facility, personnel and equipment usage trends by industry, region, size, etc. This data can be constantly updated and made accessible to individual clients.

In addition to analysis, the reporting module generates formatted forms and reports of the analyzed data to shorten project timelines, improve communication and manage risk. For example, if an asset needs to be purchased the software generates a notification. There are also numerous health and safety reports that can be generated such as emergency egress plans, areas of refuge, etc.

It should now be apparent that the foregoing software solution is user-friendly and offers the most accessible and easiest-to-use office management solution available. The floor plan interface makes viewing and editing completely intuitive and visual, and any subscribing user can use the interface with no special training.

To locate any asset a filtered search can find it/them quickly and easily. Moreover, the analysis module allows ready access to key management data such as space forecasting for budgetary reasons. The reporting module makes it easy to generate reports such as work orders for moves, adds & changes, and financial reports and depreciation schedules. Health and safety is improved with emergency egress plans (viewable on any desktop), highlighted areas of refuge and ready identification of specific employees needing emergency aid. Employees certified in CPR or other special skills can be located rapidly by any employee. Hazardous materials locations can be highlighted, and disaster supplies can be maintained with location and aging schedules.

It is an affordable single solution for Facilities, IT and basic HR data, and the web-enabled ASP platform means that there is no software to install or maintain. Both people and assets can be moved with a single drag-and-drop action, and subscribers can easily study alternatives with the “what if?” scenario capabilities, or visually analyze time-related conditions such as future occupancy of an office on a particular future date.

Moreover, the software can readily be used for managing other facilities such as parking facilities simply by establishing business rules for parking assignments, such as occupancy of reserved and non-reserved spaces.

The net result is an a new ability to reduce costs for underutilized, redundant, or outdated assets, capture corporate standards and bulk purchasing opportunities, justify cost allocations with accurate information, and compare local utilization against peer benchmarks.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. The system is robust and can support a number of different implementations. It is to be understood, therefore, that the invention may be practiced otherwise than as specifically set forth in the appended claims.

What is claimed is:

1. A spatial database interface for managing assets in a graphical user environment, comprising:
a central web-enabled server accessible by remote computer stations over a communication backbone;
a database resident on said central server and containing at least one geo-spatial layout in SVG or other browser rendering format, and a plurality of asset records each containing asset data quantifying a corresponding asset, said asset records also containing mapping data for positioning said assets on said SVG geo-spatial layout;
user-interface software resident on said central server for displaying a library of assets in a first window pane, and said geo-spatial layout in a second window pane;
whereby a user can click and drag an asset icon from said first window pane and position it in said second window pane and to visually represent an actual asset on said geo-spatial layout, and the mapping data of said corresponding asset record is automatically changed to indicate the position.

2. The spatial database interface according to claim 1, wherein said asset records each contain asset data quantifying corresponding assets by asset class, asset subclass, asset type, and by attributes of said asset class.

3. The spatial database interface according to claim 1, wherein said geo-spatial layout in said second window pane comprises a vector floor plan.

4. The spatial database interface according to claim 3, wherein an asset that is dragged from said library of assets in said first window pane to said vector floorplan in said second window pane is represented thereon by an icon.

5. The spatial database interface according to claim 4, wherein a user can position a cursor over said icon to engender a bubble window containing asset data quantifying that corresponding asset.

6. A software solution for managing facilities inclusive of office or other floor-plan layouts and assets therein, comprising;
a central web-enabled server accessible by remote computer stations over a communication backbone;
a database resident on said central server and containing at least one geo-spatial layout in SVG or other browser rendering format, and a plurality of asset records each containing asset data quantifying a corresponding assets, said asset records also containing mapping data for positioning said assets on said geo-spatial layout;
user-interface software resident on said central server for displaying a library of asset icons in a first window pane, and said geo-spatial layout in a second window pane;
whereby a user can click and drag an asset icon from said first window pane and position it in said second window pane and enter asset data into the corresponding asset record to visually represent an actual asset on said geo-spatial layout.

7. A method for managing combined organizational, financial and space design data, comprising the steps of:
gathering human resource, physical asset, and facilities data for a particular customer occupying a particular building and entering said data into a computer database;
assembling a floor plan for said particular building in a vector graphic format and storing said floor plan in said computer database;
establishing space standards for said particular customer occupying said particular building and entering said standards into said computer database;
associating said human resource, physical asset, and facilities data in said database to said vector graphics floorplan; and
displaying said floor plan in a graphical user interface together with said associated human resource, physical asset, IT, and facilities data.

8. The method according to claim 7, further comprising a step of analyzing said human resource, physical asset, and facilities data in said database in accordance with said space standards.

9. The method according to claim 8, further comprising a step of generating a report of said analysis to facilitate reallocation of said human resource, physical asset, or facilities.

10. A computer software method for managing office facilities inclusive of office layouts, physical assets and human resources within a confined office space, comprising:
a vector graphic floor plan representing a confined office space subdivided into defined areas;
a database containing human resource data, physical asset data, networks ports, and equipment asset data, all of said data being associated with the defined areas of said vector graphic floor plan; and
a graphical user interface for displaying said vector graphic floor plan and for selectively displaying said data thereon in proximity to its associated defined areas.

11. The computer software method according to claim 10, wherein said user interface further comprises a floor plan navigation panel for identifying defined office layouts, physical assets and human resources, floor plan editing panel for displaying said vector graphic floor plan, and a data grid for displaying the associated database data.

12. The computer software method according to claim 11, wherein said user interface allows clicking and dragging of physical assets and human resources from said floor plan navigation panel onto said floor plan editing panel for association with defined areas of said vector graphic floor plan.
